(19) United States
(12) Patent Application Publication
(10) Pub. No.: US 2008/0149358 A1
(43) Pub. Date: Jun. 26, 2008

(54) Cultivator kit

(76) Inventor: Bruce Leon Catlin, West Valley City, UT (US)

Correspondence Address: MARCUS G THEODORE, PC, 466 SOUTH 500 EAST, SALT LAKE CITY, UT, 84102, US

(21) Appl. No.: 12/001,867

(22) Filed: Dec. 13, 2007

Related U.S. Application Data
(60) Provisional application No. 60/876,031, filed on Dec. 20, 2006.

(51) Int. Cl. A01B 33/06

(52) U.S. Cl. 172/41

(57) ABSTRACT

A universal cultivator kit with an extendable shaft, which includes quick release systems, such as locking pins, compression fittings, snap buttons, etc. with a plurality of interchangeable cultivator blades for either manual or rotary powered drive of the different cultivator blades.

### RELATED APPLICATIONS

This application is a continuation-in-part patent application of the provisional patent application entitled “Cultivator Kit”; Ser. No. 60/876,031 filed Dec. 20, 2006.

### BACKGROUND OF THE INVENTION

1. Field

This invention pertains to cultivators. More particularly, it relates to a universal cultivator attachment kit with interchangeable components for manual or rotary powered drive of different cultivator blades.

2. State of the Art

A number of cultivators are known. J. S. Allen, U.S. Pat. No. 2,082,476 issued Jun. 1, 1937 discloses a hand powered garden tool. J. K. Schumacher, U.S. Pat. No. 643,165 issued Feb. 13, 1900 discloses a hand powered weeding implement. Hound Dog Products, Inc. of Eden Prairie, Minn. produces a number of hand powered hand tool cultivators, such as its three pronged Mini-Tiller, and its six pronged Garden Hound Tiller. These manual tools require a user to rotate the tool prongs to till the soil and are of limited use for smaller plots. Faultless Starch/Bon Ami Company of Kansas City, Mo. also produces a similar line of hand cultivators, such as its Garden Claw™.

Other powered cultivators such as McKill, U.S. Pat. No. 6,722,444 issued Apr. 20, 2004 provides a rotary hand-held tilling and weed removing device attachable to the chuck of a power drill. Schneider, U.S. Pat. No. 4,213,504 issued Jul. 22, 1980 discloses a rotary, hand-held apparatus for performing various soil working operations powered by a power drill. Motosko, U.S. Pat. No. 6,955,227 issued Oct. 18, 2005 discloses a disc auger powered by an electric drill. Alberto, U.S. Pat. No. 3,444,934 issued May 20, 1969 discloses a lawn weeder powered by a power drill. Howard, U.S. Pat. No. 5,810,093 issued Sep. 22, 1998 discloses a multipurpose landscaping device for use as a hand-held rotary power tool. It has a shaft with one end adapted for attachment to a power drill, and the other end adapted for use with a greenery cutter, a blower, a pruner, a U-shaped soil auger and a weed extractor. Jerez, U.S. Pat. No. 5,491,963 issued Feb. 20, 1996 discloses a garden cleaning implement with rotating rectangular blade cutting members for cutting/macerating weeds above and below ground. Jerez, U.S. Pat. No. 6,247,539 issued Jun. 19, 2001 discloses a cultivator implement with castellated cultivating protrusions and multi-implement powered cultivation system using spool filament and bumper feed for cutting. Marshall et al, U.S. Pat. No. 6,189,627 issued Feb. 20, 2001 discloses a lawn and garden tool arranged to provide low speed and high torque to power various implements such as tillers and drills. Marshall's tiller blade arrangement has a tendency to wander when in use and consequently requires directional control assistance from a handle.

Other farm tiller implements employing riding vehicles are known, but are not suitable for use with smaller plots or gardens.

Cited for general interest is Spence, U.S. Pat. No. 4,289,214 issued Sep. 15, 1981 disclosing a multi-purpose vehicle, which can be used with tillers and other farm implements.

The invention described below provides a cultivator kit for adapting manual or power drills with a telescoping shaft attachment kit for use with different blades for smaller plots and provides the advantages of an improved tiller blade design, which can be used laterally as well as horizontally to minimize migration.

### SUMMARY OF THE INVENTION

The invention is a cultivator kit comprising an adjustable extendable length shaft with an attachment end adapted to attach to either a manual or powered rotary power source to rotate the shaft, and a cultivator attachment end. A plurality of interchangeable cultivator blades is included in the kit, each with a securing end structured to attach removably to the shaft cultivator attachment end. The cultivator blades have a tilling end with a plurality of blade tips. When the securing end is attached to the shaft, the cultivator blade tips are aligned relative to the shaft to provide different width and angled blade structures. The different blade structures range from the blades held in parallel alignment for coring to an angled alignment for tilling and weed removal. The cultivator kit thus includes a variety of interchangeable different angled and spanned cultivator blades to cultivate soils with different compaction and tiller width areas. The preferred blade structure is structured to drill into the soil and entangle weeds there around the cultivator blade and shaft as the cultivating blade attachment is rotated.

In one preferred embodiment, the extendable shaft has extendable nested telescoping sections, which are secured at the desired length. One of the ends of the telescoping section has a power attachment end adapted to removably attach to either a manual or powered rotary power source to rotate the shaft. In one preferred embodiment, the power attachment end is adapted to attach to connectors, which removably couple to either a manual hand crank or a powered rotary power drill. The telescoping sections are of different lengths selected for assembly at the desired minimum and maximum extension length. One of these other telescoping sections has a cultivator end opposite the power attachment end to attach to a plurality of different cultivating blades. Preferably, these telescoping sections are approximately 12 inches when collapsed, and 24 inches when extended. However, longer or shorter lengths are possible by connecting additional or longer or shorter length sections together to adjust the cultivator tool's height for use by different user's and for different tasks.

Quick release locking means, such as cotter pins, compression couplings, twist fasteners, locking systems, and other similar fast release fasteners and/or systems are associated with the telescoping sections to removably secure them at a desired length. Preferred locking means are ball detents, also known as snap-buttons, mounted on an interior telescoping section which fit within a plurality of holes along the length of an exterior telescoping section to removably secure the telescoping sections at a desired length. Ball detents have the advantage of allowing the shaft to be driven in either direction without loosening the couplings. For uni-directional drive shafts, another preferred locking means are twist compression couplings, which secure the telescoping sections at the desired length in the extended mode and untwist to release the telescoping sections for storage in a collapsed mode, such as those described in U.S. Pat. No. 6,761,501. Other similar couplings may be applied.

Preferred locking means are balanced to prevent shaft wobbling when rotated. Thus symmetrical double ball detents projecting through opposing holes on opposite sides of the shaft are preferred. The double ball detents also provide the added security of a second fastener point to insure that the locks are not released in the event one accidentally slips out of its hole. As the twist compression couplings are symmetrical, they also provide a balanced rotating coupling.

A removable cultivator blade attachment with a securing coupling base is structured to removably attach to the cultivator end of the shaft. These cultivator blade attachments are of different configurations and are interchanged as needed.

One preferred cultivator blade attachment has a central drill point attached to the center of the coupling base such that its drill tip prevents blade migration during usage. At least three spaced apart blades are attached to the coupling base with tips extending about and surrounding the central drill point at a lesser extended distance to drill into the soil. As this cultivating blade attachment end is rotated, it entangles weeds there around. In another preferred embodiment, the drill point has a pair of opposite angled blades with tips interposed between the spaced apart blades to catch weeds proximate the drill point such that the opposite angled blade tips do not extend as wide as the spaced apart blades so they are not in planer alignment with the spaced apart blade tips. Thus positioned, these angled blades attach to weeds proximate the center of the drill tip.

To assist in removing entangled weeds, the rotating shaft is reversed to unwind the entangled weeds. The double ball detent configuration is particularly suited for dual direction drilling.

In one embodiment, the telescoping shaft attachment end is adapted to removably snap onto a drill coupling, which fits within a drill chuck of a power drill or attaches to the shaft of a power motor. Preferred rotary power sources are variable speed drills, which have low speed and high torque settings. These lower speed settings prevent excessive blade speeds from wildly throwing about cultivated soil.

The telescoping shaft attachment end is also adapted to removably snap onto a manual hand crank and other manual and power torque drive. For example, a preferred manual drive has the attachment end adapted to removably attach to a crank with handles included in the cultivator kit to rotate manually the shaft and turn the blades. The telescoping shaft and cultivator blade attachments thus can be used with either rotary or manual power sources, in a manner to enable use of different interchangeable cultivator blade attachments for operation at various shaft lengths by a user.

The invention thus provides an improved manual or power drill cultivator kit with interchangeable cultivator blades and a variable length shaft for use with smaller plots. It also provides the advantages of interchangeable tiller blade designs, which can be used laterally as well as horizontally to minimize migration. Lateral usage is particularly effective when one wants to disc the soil. Horizontal usage is better adapted for a drilling type of action. When not in use with cultivator blades, the cultivator kit may be use to power other rotary blade attachments, such as those described below to perform a varitety of different tasks.

### DESCRIPTION OF THE DRAWINGS

FIG. 1 is a perspective view of a hand crank attachment.

FIG. 2 is a perspective view of an extendable telescoping shaft.

FIG. 3 is a perspective view of a removable drill coupling.

FIG. 4 is a perspective view of an interchangeable four blade cultivating blade attachment with a vertical stabilizer.

FIG. 5 is a perspective view of an interchangeable four blade cultivating blade attachment.

FIG. 6 is a perspective view of an interchangeable four blade cultivating blade attachment with a horizontal stabilizer.

FIG. 7 is a perspective view of an interchangeable sanding disk attachment.

FIG. 8 is a perspective view of an interchangeable rotary buffer attachment.

FIG. 9 is a perspective view of an interchangeable cork screw drill attachment.

FIG. 10 is a perspective view of a sponge/cloth attachment.

FIG. 11 is a perspective view of a polishing attachment.

### DESCRIPTION OF THE ILLUSTRATED EMBODIMENTS

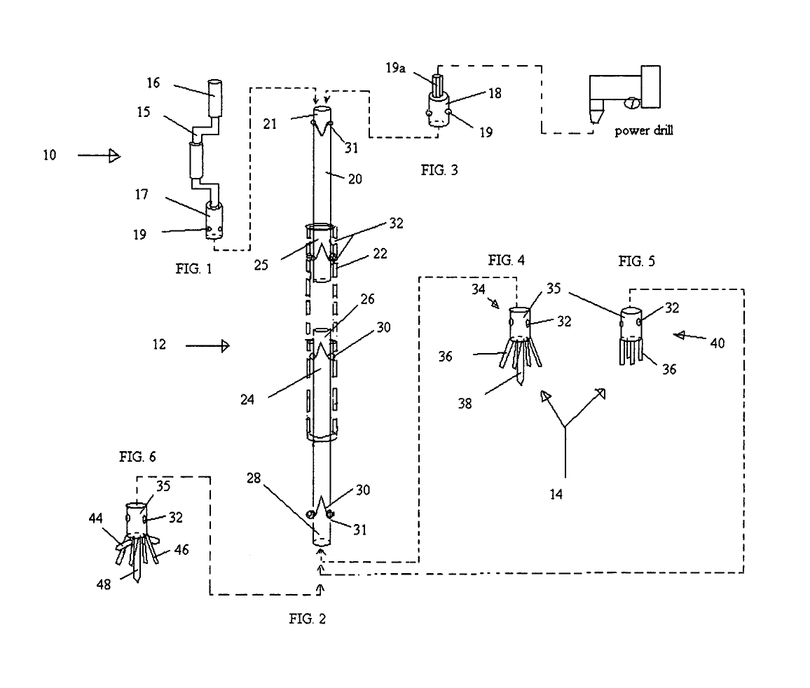

FIG. 1 is a perspective view of a hand crank attachment 10 constructed of a bent shaft 15 with cylindrical handles 16, and a crank shaft coupling 17 with holes 19 adapted to fit the power attachment end 21 of a telescoping tubular shaft 12 shown in FIG. 2. FIG. 3 is a perspective view of a removable drill coupling 18 with holes 19 similarly positioned to those in the shaft coupling 17. The drill coupling 18 has an end 19a structured to fit within and be held by the chuck of a power drill. The shaft coupling 17 and the drill coupling 18 are similarly structured to interchangeably attach to the power attachment end of the extendable telescoping tubular shaft 12.

FIG. 2 is a perspective view of an extendable telescoping shaft 12 with multiple telescoping sections 20, 22, and 24. Although FIG. 2 shows three telescoping sections, other configurations with more or fewer telescoping sections are within the scope of this invention. The power attachment end 21 of the first telescoping section 20 has a double spring ball detent 30 mounted within holes 31 near the power attachment end 21 of the first telescoping section 20 and the cultivating attachment end 25. These power attachment end 21 holes 31 are structured to align with the holes 19 of a crank shaft coupling 17 or a drill coupling 19. The cultivator attachment end 21 is removably held to the couplings 17 and 18 by the double spring ball detents 30 extending through aligned holes 31 and 32.

The exterior telescoping section 22 has a plurality of holes 32 in parallel alignment along its length such that its holes 32 can be aligned with section 20 holes 31 and removably secured thereto by the double spring ball detent 30. The double spring ball detent 30 is preferred to secure couplings 17 and 18 as they provide a symmetrical coupling alignment to prevent wobbling when the telescoping shaft 12 is rotated. Although a double spring ball detent 30 is shown, a compression coupling (not shown) could also be employed because of its symmetrical securing structure.

Interior telescoping section 24 is similarly slideably mounted within the interior of telescoping section 22 and secured with a similar double spring ball detent 30 in holes 31 in its shaft attachment end 26 to removably secure telescoping section 24 to telescoping section 22. The other cultivator attachment end 28 of telescoping section 24 has a double spring ball detent 30 with holes 31 for attachment to a cultivating blade attachment 14 with different blade configurations, such as those two shown in FIG. 4.

FIG. 4 is a perspective view of an interchangeable four blade cultivating blade attachment 34 with a vertical stabilizer 38 surrounded by four blade cultivating blades 36. These have a coupling end 35 with similar aligned holes 32 to removably secure to the holes 31 of cultivator attachment end 28 of telescoping section 24 via a double spring ball detent 30.

FIG. 5 is a perspective view of an interchangeable four blade cultivating blade attachment 40 without a vertical stabilizer. It has a similar coupling end 35 with similarly aligned holes 32. Its four blades 36 are in parallel alignment for core removal of dandelions.

Although FIGS. 4 and 5 illustrate two preferred different blade configurations, other interchangeable cultivating blade attachments 14 with different blade configurations, such as that shown in FIG. 6, may be included.

FIG. 6 is a perspective view of an interchangeable four blade cultivating blade attachment 42 with a horizontal stabilizer 44 attached at the base of the blades 46. A second pair of horizontal stabilizer blades 44 are interposed between the four equally spaced apart cultivating blades 36 with their tips spread apart wider such that they are not in planer alignment. These stabilizer blades 44 act as horizontal stabilizers to minimize blade migration when in use on an angle. This embodiment has a similar coupling end 35 with similarly aligned holes 32 for attachment.

Thus, in the simplest embodiment, at least three cultivating blades 36 attached to a coupling end 35 to removably attach to the cultivator end of the shaft 12. For dandelion removal, four blades 36 equally spaced apart and in parallel alignment are attached to a coupling end 35 to removably attach to the cultivator end of the shaft 12 such that when they are rotated a tubular soil core containing roots is removed.

To prevent the cultivating blades 36 from migrating during use, a vertical stabilizer 38 structured as a drill point may be included and positioned in the center of the spaced apart blades 36. The vertical stabilizer 38 extends beyond the cultivating blades 36 to drill into the soil and hold the position of the cultivating blades 36 as they rotate cultivating and tilling the soil. This particular embodiment is used to “drill” a series of cultivating holes to churn and till the soil. A user can then remove the entangled weeds from the cultivating blades 36 or till them into the soil for mulch.

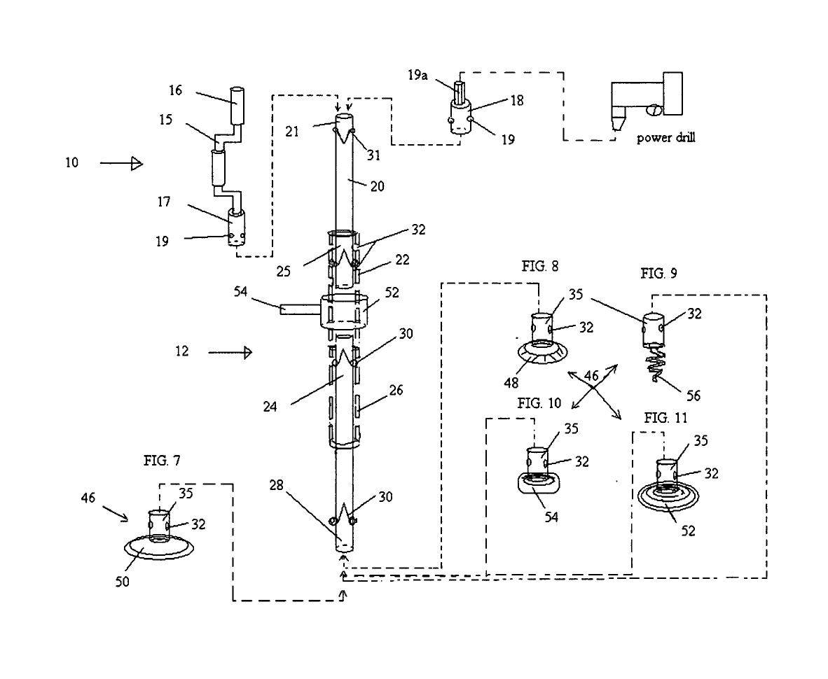

The cultivator kit may also include various interchangeable rotary power tool attachments 46 each with a coupling end 35 structured to attach removably to the shaft 12 cultivator attachment end 21 to perform different rotary tasks when the cultivator kit is not used for cultivation. Preferred rotary power tool attachments 46 shown in FIGS. 7, 8, 9, 10 and 11 are a rotary buffer 48, a sanding disk 50, a polishing attachment 52, a sponge/cloth attachment 54 for cleaning/polishing, and a cork screw drill 56.

As shown in FIGS. 7-11, a tubular hand guide 52 surrounding the shaft, may be included to enable the shaft to spin freely within the tubular hand guide, which is structured to be held by one hand to assist in controlling the tool alignment. The tubular hand guide 52 may have a handle 54 affixed at right angles to the tubular hand guide to assist a user in alignment.

As the various components have interchangeable attachment ends, they can be mixed and matched as needed to provide the required shaft length, blade configuration, and power drive required by a user for a particular application.

The above description and specification should not be construed as limiting the scope of the claims. The claims themselves recite those features deemed essential to the invention.

I claim:

1. A cultivator kit comprising:
a. a shaft with
i. a power attachment end structured to attach to either a manual or powered rotary power source to rotate the shaft, and
ii. a cultivator attachment end structured to attach to cultivator blades; and
b. a plurality of interchangeable cultivator blades each with a securing end structured to fit around the cultivator attachment end to attach removably to the cultivator attachment end of the shaft, and a tilling end with a plurality of blade tips to provide different width and angled blade structures from a parallel alignment for coring to an angled alignment for tilling, wherein the span of the blade tips varies to cultivate soils with different compaction and tiller width areas, and structured to drill into the soil and entangle weeds there around as the cultivating blade attachment is rotated.

2. A cultivator kit according to claim 1, wherein the shaft is adjustable in length.

3. A cultivator kit according to claim 2, wherein the shaft includes at least one exterior slideably nested telescoping section structured to slide onto an interior shaft, and couplings associated with the telescoping sections to removably secure them together at a desired extension; said couplings symmetrically structured to prevent the shaft from wobbling or releasing upon shaft rotation.

4. A cultivator kit comprising:
a. an interior shaft with
i. a power attachment end adapted with holes structured to attach to either a manual or powered rotary power source to rotate the shaft, and
ii. a cultivator attachment end with holes structured to attach to cultivator blades;
b. spring ball detents mounted to retractably project through the holes in the power attachment end and the cultivator attachment end,
c. a power coupling with one end structured to attach to a manual or power rotary source, and a base structured to fit around the power attachment end and having corresponding holes into which the double spring ball detents retractably secure the power coupling to the power attachment end, and
d. a plurality of interchangeable cultivator blades each with a securing end structured to fit around the cultivator attachment end having corresponding holes structured to attach removably to the cultivator attachment end of the shaft when the double spring ball detents retractably secure the securing end into the holes in the shaft cultivator attachment end, and a tilling end with a plurality of blade tips when the securing end is attached to the shaft to provide different width blade structures from a parallel alignment for coring to an angled alignment for tilling, wherein the span of the blade tips varies to cultivate soils with different compaction and tiller width areas, and structured to drill into the soil and entangle weeds there around as the cultivating blade attachment is rotated.

5. A cultivator kit according to claim 4, including at least one exterior slideably nested telescoping section structured to slide onto the interior shaft, each having a corresponding series of symmetrically aligned holes to be secured by the retractable spring ball detents to position and extend the telescoping sections to form a shaft of a desired length.

6. A cultivator kit according to claim 4, wherein the spring ball detents are double spring ball detents, and the aligned holes in the power attachment end and the cultivator attachment end are symmetrically opposed and aligned such that the shaft will not wobble when connected to the cultivator blade and power rotary source, when rotated at high speeds.

7. A cultivator kit according to claim 4, wherein at least one of the cultivator blades has at least four equally spaced apart spiked blades in parallel alignment to form a coring blade.

8. A cultivator kit according to claim 4, wherein one or more of the cultivator blades has at least three equally spaced apart spiked blades attached circumferentially in radially spaced apart downward alignment to the cultivator end at an angle to spread the separated tips at an acute angle relative to the shaft.

9. A cultivator kit according to claim 8, wherein at least one cultivator blade for angled alignment includes a central stabilizer comprising a central drill point attached to the center of the cultivator end with a drill tip extending beyond the tips of the blades to drill into soil.

10. A cultivator kit according to claim 4, including a crank with handles adapted to attach to the shaft attachment end to rotate the shaft and turn the blades when the handles are turned manually.

11. A cultivator kit according to claim 4, wherein at least one cultivator blade includes a horizontal stabilizer comprising a horizontal pair of blades with tips affixed to the center of the attachment end such that the horizontal blade tips are interposed between the spaced apart blades and are spread apart wider and not in planer alignment with the spaced apart blade tips to act as a horizontal stabilizer to minimize blade migration and disc soil when the cultivator blades are used in acute angular alignment with the soil.

12. A cultivator kit according to claim 4, including a tubular hand guide surrounding the shaft to enable the shaft to spin freely within the tubular hand guide structured to be held by one hand to assist in controlling the tool alignment.

13. A cultivator kit according to claim 12, wherein the tubular hand guide has a handle affixed at right angles to the tubular hand guide to assist a user in alignment.

14. A cultivator kit according to claim 4, wherein at least one cultivator blade is structured with
i. at least three equally spaced apart outwardly bent spiked blades each attached to a base end with each blade bent such that their tips are spaced apart and planarly aligned normal to the shaft and structured to drill into the soil as the cultivating blade attachment is rotated to entangle weeds, when turned, and
ii. a vertical or horizontal stabilizer structured attached to the center of the base end adapted to drill into the soil to minimize blade migration when rotated during use.

15. A cultivator kit according to claim 4, including various interchangeable rotary power tool implements each with a securing end structured to attach removably to the shaft cultivator attachment end to perform different rotary tasks when the cultivator kit is not used for cultivation.

16. A cultivator kit according to claim 15, wherein the cultivator attachment end is adapted either as a rotary buffer, a sanding disk, a polishing attachment, a sponge/cloth attachment for cleaning/polishing, or a cork screw drill.

17. A cultivator kit according to claim 4, including at least one exterior slideably nested telescoping section structured to slide onto the interior shaft, each having compression couplings to position and extend the telescoping sections to form a shaft of a desired length so that the retractable double spring ball detents can then removably secure to the shaft the power coupling and cultivating blades.

18. A cultivator kit comprising:
a. an interior shaft with
i. a power attachment end adapted with opposite symmetrically aligned holes structured to attach to either a manual or powered rotary power source to rotate the shaft, and
ii. a cultivator attachment end with opposite symmetrically aligned holes structured to attach to cultivator blades;
b. at least one exterior slideably nested telescoping section structured to slide onto the interior shaft, each having a corresponding series of symmetrically aligned holes, which are secured by retractable double spring ball detents to position and extend the telescoping sections to form a shaft of a desired length,
c. double spring ball detents mounted to retractably project through the holes in the power attachment end and the cultivator attachment end,
d. a power coupling with one end structured to attach to a manual or power rotary source, and a base structured to fit around the power attachment end having corresponding holes into which the double spring ball detents retractably secure the power coupling to the power attachment end, and
e. a plurality of interchangeable cultivator blades each with a securing end structured to fit around the cultivator attachment end having corresponding holes structured to attach removably to the cultivator attachment end of the shaft when the double spring ball detents retractably secure the securing end into the holes in the shaft cultivator attachment end, and a tilling end with a plurality of blade tips when the securing end is attached to be aligned relative to the shaft to provide different width blade structures from a parallel alignment for coring to an angled alignment for tilling, wherein the span of the blade tips varies to cultivate soils with different compaction and tiller width areas, and structured to drill into the soil and entangle weeds there around as the cultivating blade attachment is rotated.

19. A cultivator kit according to claim 18, wherein the spring ball detents are double spring ball detents, and the aligned holes in the power attachment end and the cultivator attachment end are symmetrically opposed and aligned such that the shaft will not wobble when connected to the cultivator blade and power rotary source, when rotated at high speeds.
